(19) United States
(12) Patent Application Publication
(10) Pub. No.: US 2015/0169034 A1
(43) Pub. Date: Jun. 18, 2015

(54) SYSTEMS AND METHODS FOR AUTOMATIC MODE CHANGING FOR A MOBILE POINT OF SALE COMPUTING DEVICE BASED ON DETECTING THE APPLICATION OF A FORCE

(71) Applicant: Toshiba Global Commerce Solutions Holdings Corporation, Tokyo (JP)

(72) Inventors: James LC Huang, Taipei 66-1 (TW); Leo CW Lee, New Taipei City (TW); Shun-Te Yu, New Taipei City (TW); Merrick Wang, Nantou (TW)

(73) Assignee: Toshiba Global Commerce Solutions Holdings Corporation, Tokyo (JP)

(21) Appl. No.: 14/188,763

(22) Filed: Feb. 25, 2014

Related U.S. Application Data
(60) Provisional application No. 61/917,389, filed on Dec. 18, 2013.

(51) Int. Cl. G06F 1/32

(52) U.S. Cl. CPC G06F 1/3234

(57) ABSTRACT

Systems and methods for automatic mode changing for a mobile point of sale computing device are disclosed herein. According to an aspect, a system comprises a mobile computing device. The system also comprises a carrying unit being attached to the mobile computing device. Further, a force detecting device is configured to detect application of a force from the carrying unit and to change an operational mode of the mobile computing device based on detection of the application of the force from the carrying unit. In another embodiment, a method comprises detecting an application of a force from a carrying unit to a force detecting device is provided. The method further changes an operational mode of a mobile computing device based on detecting the application of the force from the carrying unit.

### CROSS REFERENCE TO RELATED APPLICATION

This application claims the benefit of U.S. Provisional Patent Application No. 61/917,389, filed Dec. 18, 2013 and titled SYSTEMS AND METHODS FOR AUTOMATIC MODE CHANGING FOR A MOBILE POINT OF SALE COMPUTING DEVICE, the content of which is hereby incorporated herein by reference in its entirety.

### TECHNICAL FIELD

The present invention relates to retail devices and equipment, and more specifically to systems and methods for automatic mode changing for a mobile point of sale computing device based on detecting the application of a force.

### BACKGROUND

In retail environments, such as grocery stores and other “brick and mortar” stores, retail personnel often operate retail equipment such as point-of-sale (POS) equipment. At POS equipment, retail personnel may operate the equipment and interact with customers for conducting purchase or purchase related transactions. Many retail equipment and systems are designed specifically for increasing sales throughput, quality of information delivered to the customer and increasing the speed of purchase transactions. Further, to better increase sales throughput, quality of information delivered to the customer and increase the speed of purchase transactions it is also desired to improve usability and mobility of the POS equipment or computing devices. For example, increasing mobility of the POS computing devices would allow better quality and more timely information to be presented to the customer.

Usability and mobility of the POS computing devices is dependent upon several factors. As an example, these factors may include size, user interfacing, connectivity and power usage of the POS computing devices. As an example, power usage of a mobile POS computing device will determine the length of possible operation of the mobile POS computing device. Thus, power usage of the mobile POS computing device will determine the number of mobile POS computing devices that are required for each retail environment. If power usage of the mobile POS computing device is high, then additional mobile POS computing devices may be required. Additional mobile POS computing devices would be required because more frequent charging of each mobile POS computing device would be necessary. In view of this need, there is a desire to provide improved power savings of POS computing devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for automatic mode changing for a mobile point of sale computing device based on detecting the application of a force. In this regard, in one embodiment, a system comprises a mobile computing device. The system also comprises a carrying unit being attached to the mobile computing device. Further, a force detecting device is configured to detect application of a force from the carrying unit and to change an operational mode of the mobile computing device based on detection of the application of the force from the carrying unit.

In another embodiment, a method comprises detecting an application of a force from a carrying unit to a force detecting device is provided. The method further changes an operational mode of a mobile computing device based on detecting the application of the force from the carrying unit.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed.

In the drawings:

FIG. 1 is a block diagram of a system comprising a mobile computing device and carrying unit which exemplifies the application of force by the carrying unit to the force detection device;

FIG. 2 is a flowchart illustrating an exemplary method for detecting the application of force in FIG. 2 and the changing of the operational mode of the mobile computing device;

FIG. 3 is flowchart illustrating an exemplary method for configuring the force detection threshold used to detect an application of a force from a carrying unit and changing the operational mode; and

FIG. 4 is a perspective view of a mobile computing device illustrating the mobile computing device engaged with the carrying unit in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

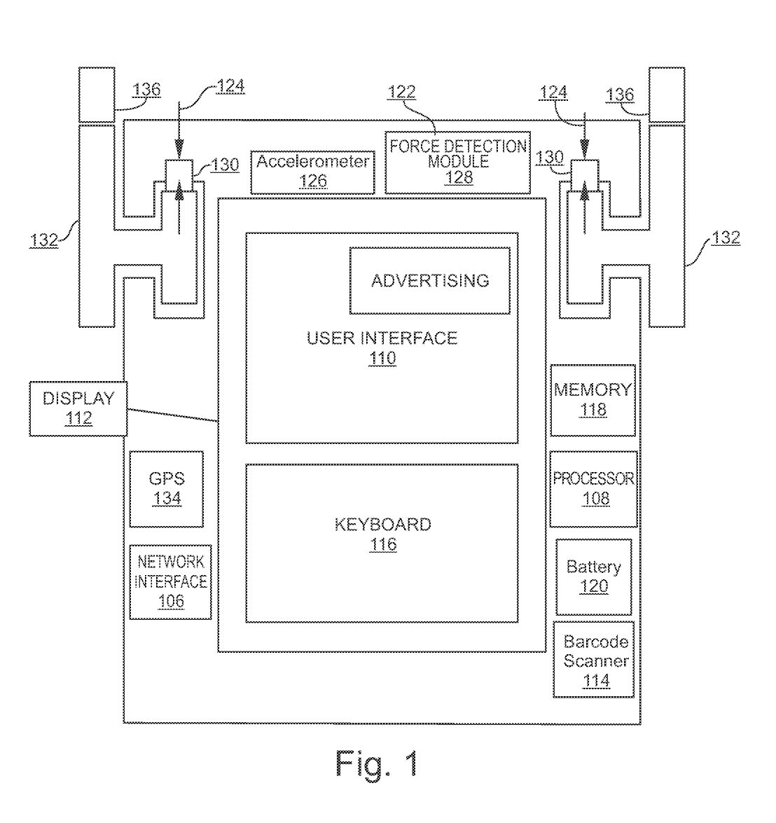

The presently disclosed invention is now described in more detail. For example, FIG. 1 illustrates a block diagram of a system 100 comprising a mobile computing device 102 and carrying unit 104 for the mobile computing device. The system 100 may be implemented in whole or in part in any suitable environment for conducting purchase transactions. For example, the system 100 may be implemented in a retail store having a variety of products or items for purchase and one or more POS terminals. For example, a mobile computing device 102 may operate as a POS terminal that can be operated by retail personnel for conducting purchase transactions with customers. The mobile computing device 102 may be communicatively connected via a communications network interface 106, which may be connected to any suitable local area network (LAN), either wireless and/or wired. The mobile computing device 102 and other components, not shown, may be configured to acquire data within the retail environment, to process the data, and to communicate the data to a centralized server. Further, a centralized server may communicate data to the mobile computing device 102 and other components of the system 100. A centralized server may reside in the retail store or be remotely located.

The components of the system 100 may each include hardware, software, firmware, or combinations thereof. For example, software residing in memory of a respective component may include instructions implemented by a processor 108 for carrying out functions disclosed herein. As an example, the mobile computing device 102 may each include a user interface 110, a display 112 (e.g., a touchscreen display), a barcode scanner 114, a keyboard 116, and/or other equipment for interfacing with retail personnel and for conducting a purchase transaction for purchase of items by customers or providing more timely information to be presented to the customer. Timely information to be presented to the customer may be in the form of advertising or specials, as an example. The mobile computing device 102 may also include memory 118. The mobile computing device 102 may be a self-checkout POS terminal or a retail personnel-assisted POS terminal. The mobile computing device 102 may also include a suitable communications network interface 106 for communicating with a network. The mobile computing device 102 may include hardware (e.g., image capture devices, scanners, and the like) for capture of various data within the retail environment. For example, the mobile computing device 102 may include the 114 bar code scanner for scanning items and customer interface equipment for allowing customers to make purchases. The mobile computing device 102 also comprises a battery 120 providing power to the mobile computing device 102. As non-limiting examples, the battery 120 may be of the type of lithium polymer (li-poly), lithium ion (Li-Ion), Nickel Cadmium (NiCd).

In continuing reference to FIG. 1, the mobile computing device 102 further comprises a force detection device 122 for detecting an applied force 124 to the mobile computing device 102 from the carrying unit 104. The force detection device 122 is comprised of an accelerometer 126, a force detection module 128 and at least one sensor 130. The threshold of sensitivity for the accelerometer 126 is configurable to detect a varying degree of applied force 124 to the mobile computing device 102 via movement as well as a lack of movement. In some embodiments a spring may be used to adjust the adjustable force detection threshold. The force detection device 122 may also detect a change of force based on sensing tension and/or compression of the detecting device. In some embodiments the force detection device 122 may be positioned outside of the mobile computing device. As an example, the carrying unit may comprise the force detection device 122. Movement of the mobile computing device 102 may be as a result of re-attachment to the carrying unit 104 or the picking up of the mobile computing device 102 by a user. Movement may also be detected based on removal of the mobile computing device 102 from the carrying unit 104. However, movement is not limited to either the engagement or disengagement with the carrying unit 104 and may be as a result of placement in a predetermined location of a retail establishment, as an example. In addition, to detecting force as a result of movement, the carrying unit 104 may also comprise a hook 132 configured to apply a force 124 to the at least one sensor 130. In this example, the mobile computing device 102 can be placed in the carrying unit 104 comprising the hook 132 which applies a force 124 to the at least one sensor 130. In this example, the force detection device 122 detects the applied force 124 from the hook 130. The force detection module 128 is configurable so as to adjust the threshold of detectable force 124 by the force detection device 122 as applied to the mobile computing device 102. The force detection module 128 may be configured through the network interface 106, the bar code scanner 114, the keyboard 116 or other inputs that may not be shown, such as buttons, switches or dials. Based upon detection of an applied force 124 to the mobile computing device 102, the mobile computing device 102 may change a current operational mode of the mobile computing device 102.

In continuing reference to FIG. 1, the operational mode may be one of a plurality of operational modes. The plurality of operational modes may be a plurality of power modes, such as, a first power mode and a second power mode. The first power mode may be a power mode, wherein more power is consumed than the second power mode. Additionally more than two (2) power modes may be configured. Further, a first operational mode may be a mode wherein a different application or computer readable instructions may be executed than in a second operational mode. As with the power modes, a plurality of operational modes, more than two (2), may be configured. As an example, the plurality of operational modes may comprise displaying on the display 112 retail store specials, location sensitive alerts (e.g., special on diapers while in the appropriate aisle of the retail store), a purchase transaction mode, and an inventory inquiry mode, as non-limiting examples. Upon the force detecting device 122 detecting an applied force 124 from the hook 132 as applied to the mobile computing device 102, the mobile computing device 102 can change the current power mode from a first power mode to a second power mode as described above or from a second power mode to a first power mode. Additionally, the current operational mode (e.g., inventory inquiry) may be changed to one of a location sensitive mode (e.g., diaper specials). Other examples of changing the operational mode may be in displaying a keyboard 116 on the display 112 or removing the keyboard 116 from the display 112. In addition to changing operational modes as described above, the mobile computing device 102 may be configured to adjust other aspects of operational mode relating to system parameters.

In continuing reference to FIG. 1, operational modes relating to system parameters may be different power modes, including wake or sleep states. Power modes may be changed by adjusting the clock speed of the processor 108, the brightness of the display 112, or sleep timeouts of the mobile computing device 102, as an example. In this manner, the mobile computing device 102 may dim or turn off the display 112 when re-attached to the carrying unit 104 as described above. To protect against an unintended change to the operational mode, it is also possible for a plurality of power modes to be determined based on a combination of time, movement of the mobile computing device 102, and location. As an example, the mobile computing device 102 may change power modes based on the application of force 124 for a predetermined period of time. The predetermined period of time may be configured for location, location may be determined by an optional GPS 134. The carrying unit 104 may be attachable to a retail employee, consumer or stationary display via an attachable device such as a belt 136. The belt 136 may also be a stationary stand, or other apparatus configured to properly mount the mobile computing device 102. The predetermined period of time may be configured by a user or the system 100.

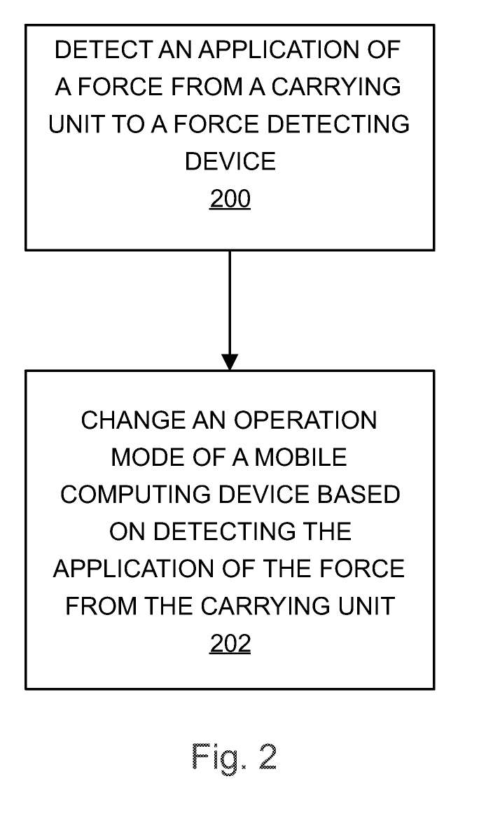

In this regard, FIG. 2 illustrates a flowchart of an example method for automatic operational mode changing of a mobile computing device 102 in accordance with embodiments of the present invention. The method of FIG. 2 is described as being implemented by a force detection device 122 of the mobile computing device 102, although the method may be implemented by any suitable computing device. The method may be implemented by hardware, software, and/or firmware of the computing device 102 and/or another computing device. For example, the memory 118 and a processor 108 of the mobile computing device 102 may implement the method.

In continuing reference to FIG. 2, detecting an application of a force 124 from a carrying unit 104 to a force detecting device 122 (block 200) is provided. The force detecting device 122 is configured to detect the application of a force 124 to the mobile computing device 102. The application of the force 124 to the mobile computing device 102 may be applied by the carry unit 104 to at least one sensor 130 or via movement as detected by the accelerometer 126 as described above. The mobile computing device 102 is able to change the operation mode of a mobile computing device 102 based on detecting the application of the force 124 from the carrying unit 104 (block 202). As described above, the changed operational mode may be one of a displayed advertisement, the execution of an application or in the changing of system parameters effecting power usage. The threshold of sensitivity for the detectable force is configurable as described above.

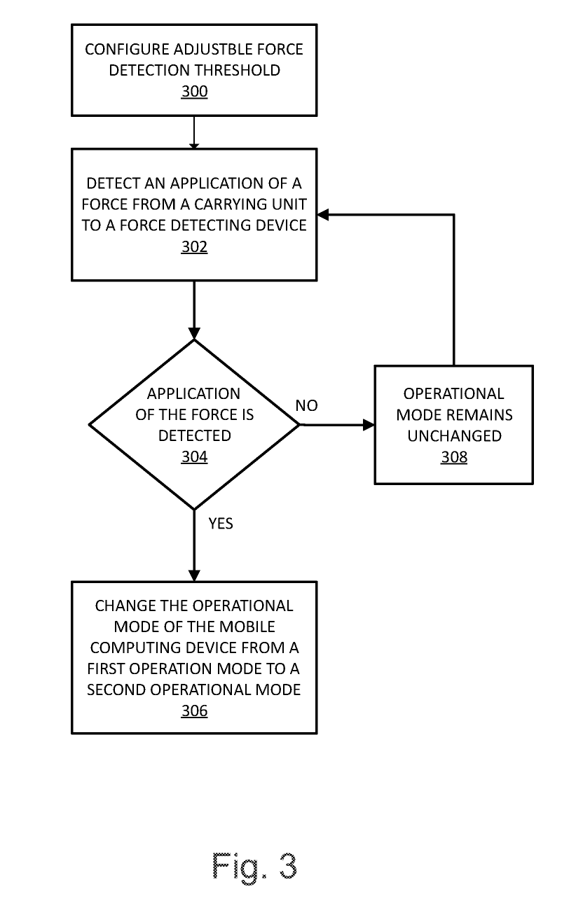

In this regard, FIG. 3 is a flowchart illustrating an exemplary method of the detecting of the applied force 124 and the changing of the operational mode of the mobile computing device 102 in additional detail. The method of FIG. 3 includes an additional step of configuring the adjustable force detection threshold so as to adjust the threshold of detectable force 124 by the force detection device 122 as applied to the mobile computing device 102 (block 300). The force detection module 126 may be configured through the network interface 106, the bar code scanner 114, the keyboard 116 or other inputs such as buttons, switches or dials (not shown). For example, the retail personnel may use the user interface 110 (e.g., a touchscreen display, keyboard, and/or mouse) to set a force detection threshold sensitivity. The force detection device 122 may control the user interface 110 for providing an interface for the user to set the force detection threshold. Subsequent to force detection threshold information being entered, the information may be provided to the force detection module 128 of the force detection device 122. Different customizations (e.g., thresholds, operational modes, etc.) may be allowed by different users based on the identification information. For example, certain retail personnel of higher positions may be allowed to set customizations that those of lower positions cannot set.

In continuing reference to FIG. 3, the method includes the step of detecting an application of a force 124 from a carrying unit 104 to a force detecting device 122 (block 302) as described above. If the force detection device 122 determines that a force 124 is detected (block 304) then changing the operation mode of the mobile computing device 102 from a first operational mode to a second operational mode (block 306). If no applied force 124 is detected the operational mode of the mobile computing device 102 will not be changed (block 308).

In accordance with embodiments of the present invention, the force detection device 122 may change the operation of the mobile computing device 102 between a work mode and a user-selected operational mode. For example, in a work mode, the mobile computing device 102 may operate for conducting purchase transactions. In a user-selected mode, the mobile computing device 102 may display or permit user-selected features, such as the operational modes described in FIG. 1 and FIG. 2. In response to determining the application of the force 124 to the mobile computing device 102, the force detection device 122 may disable one or more operational modes. In another example, an operator of the mobile computing device 102 may interact with the user interface 110 for instructing the mobile computing device 102 to switch between the work and user-selected feature modes.

In continuing reference to FIG. 3, other example features that can be set by a user include, but are not limited to, computer or GUI widgets. Example GUI widgets include sports score and information tickers, rich site summary (RSS) feeds, social networking feeds, and the like. Example features also include providing access to Internet content, providing access to personal content, providing access to entertainment content, providing access to gaming content, providing RSS feed content, providing a GUI feature, providing social networking content, and the like.

In accordance with embodiments of the present invention, operational modes may be enabled for a predetermined time period. For example, the operational modes may be enabled for a predetermined time period after the application of a force 124, so as to prevent unintended changing of the operational mode. The operational mode may also be disabled after the predetermined time period. Although the operational mode may be enabled again once the application of force 124 has met predetermined criterion again as described above in FIG. 1.

An example advantage of embodiments of the present invention is an increase in sales through higher quality of information delivered to the customer and improved usability and mobility of the POS equipment or mobile computing devices 102. Increased mobility of the POS equipment or mobile computing devices 102 may be achieved by more efficient power usage of the mobile computing devices 102. More efficient power usage can offer extended time between charging also resulting in the need for fewer mobile computing devices 102. For example, increasing extended time between charging the mobile computing devices 102 would allow better quality and more timely information to be presented to the customer with the need for fewer mobile computing devices 102. Increased mobility may be achieved through the use of more efficient power modes being automatically selected based on position, location or operational status of the mobile computing device 102.

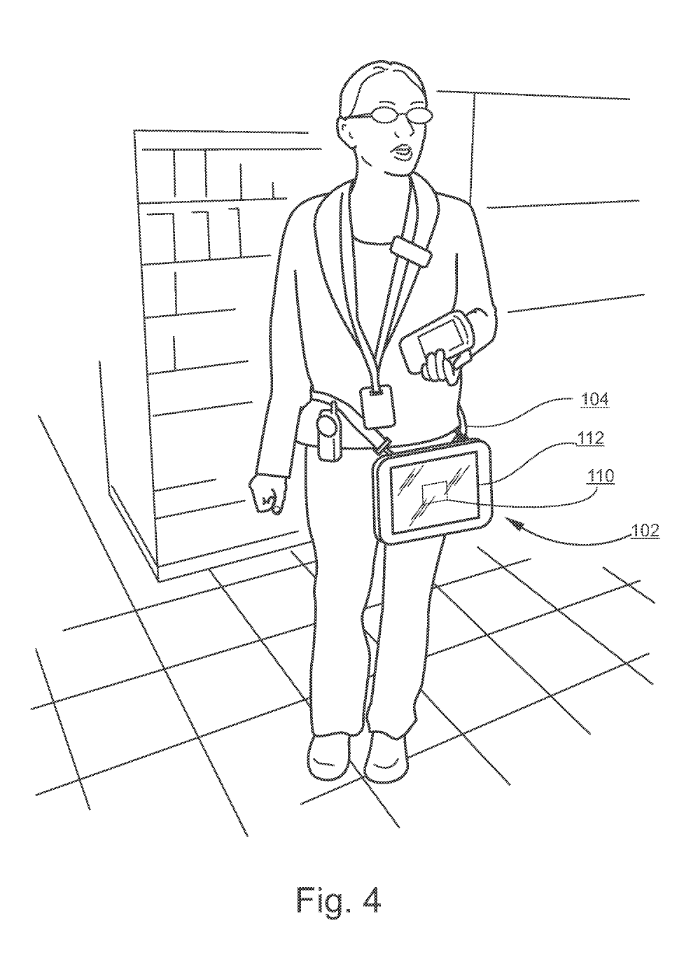

In this regard, FIG. 4 illustrates a user 400 with a mobile computing device 102 engaged with the carrying unit 104. The mobile computing device 102 may be set to a first operational mode while being carried by the user 400. The first operational mode may be a mode wherein the mobile computing device 102 alerts the user by displaying an advertisement in the user interface 110 on the display 112 or through sound or vibration of a special of particular interest to the user 400 based on the location of the user 400. Another example of a first operational mode, may be when carried by a user 400 it may be important to additionally operate in a higher power mode which is able to use the GPS 134. However, when the user 400 is no longer using the mobile computing device 102, the user 400 may disengage the mobile computing device 102 from the carrying unit 104 and place the mobile computing device 102 in an alternate holder. Additionally, the mobile computing device 102 may detect a lack of movement for a period of time and as a result switch to a lower power mode when not in use. Thus, it may be desired to change to a second lower power operational mode as a result. In this manner, decreasing power usage and extending the service operation of the mobile computing device 102.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A system comprising:
a mobile computing device;
a carrying unit being attached to the mobile computing device; and
a force detecting device configured to detect application of a force from the carrying unit and to change an operational mode of the mobile computing device based on detection of the application of the force from the carrying unit.

2. The system of claim 1, wherein the operational mode of the mobile computing device comprises a plurality of power modes.

3. The system of claim 2, wherein the plurality of power modes comprises a first power mode and a second power mode, and
wherein the force detecting device is configured to change the mobile computing device from the first power mode to the second power mode in response to detection of the application of force to the carrying unit.

4. The system of claim 3, wherein the first power mode of the mobile computing device is a higher power consuming mode than the second power mode.

5. The system of claim 1, wherein the operational mode of the mobile computing device changes from a first operational mode to a second operational mode in response to detection of the application of force to the carrying unit.

6. The system of claim 1, wherein the force detecting unit is configured to determine application of the force to the carrying unit for a period of time and to change the operational mode in response to determining that the force is applied to the carrying unit for at least the period of time.

7. The system of claim 1, wherein the force detecting device comprises an accelerometer, and wherein the force detecting device is configured to use the accelerometer to detect the application of force to the carrying unit.

8. The system of claim 1, wherein the force detecting device has an adjustable force detection threshold.

9. The system of claim 8, further comprising using a spring to adjust the adjustable force detection threshold.

10. The system of claim 1, wherein the force detecting device detects a change of force based on one of tension and compression of the detecting device.

11. The system of claim 1, wherein the force detection device is included in the mobile computing device.

12. The system of claim 1, wherein the force detection device is outside of the mobile computing device.

13. The system of claim 1, wherein the force detecting device comprises one or more sensors configured to detect the application of force.

14. A method comprising:
detecting an application of a force from a carrying unit to a force detecting device; and
changing an operational mode of a mobile computing device based on detecting the application of the force from the carrying unit.

15. The method of claim 14, wherein changing an operational mode of the mobile computing device comprises a plurality of power modes.

16. The method of claim 15, wherein the plurality of power modes further comprises a first power mode and a second power mode, and
wherein the detecting the application of the force from the carrying unit comprises changing the mobile computing device from the first power mode to the second power mode in response to the detecting of the application of the force to the carrying unit.

17. The method of claim 16, wherein the first power mode of the mobile computing device is a higher power consuming mode than the second power mode.

18. The method of claim 14, wherein changing the operational mode of the mobile computing device from a first operation mode to a second operational mode is in response to detecting the application of the force to the carrying unit.

19. The method of claim 14, wherein detecting the application of the force from the carrying unit comprises determining the application of the force to the carrying unit for a period of time.

20. The method of claim 19, wherein changing the operational mode is in response to determining that the force is applied to the carrying unit for at least the period of time.

21. The method of claim 14, wherein detecting the application of the force from the carrying unit comprises using an accelerometer to detect the application of force from the carrying unit.

22. The method of claim 14, wherein detecting the application of the force from the carrying unit comprises an adjustable force detection threshold.

23. The method of claim 22, wherein detecting the application of the force from the carrying unit further comprises using a spring to adjust the adjustable force detection threshold.

24. The method of claim 14, wherein detecting the application of the force from the carrying unit is in response to one of tension and compression of the detecting device.

25. The method of claim 14, wherein detecting the application of the force from the carrying unit comprises the mobile computing device including the force detecting device.

26. The method of claim 14, wherein detecting the application of the force from the carrying unit comprises the detection device is outside of the mobile computing device.

27. The system of claim 14, wherein detecting an application of a force from a carrying unit comprises one or more sensors configured to detect the application of force.
